(19) United States
(12) Patent Application Publication
(10) Pub. No.: US 2004/0084801 A1
(43) Pub. Date: May 6, 2004

(54) Method of manufacturing risers for shelving units

(76) Inventors: Gregory S. Floyd, Wooster, OH (US); Robert G. States III, Wooster, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/287,295

(22) Filed: Nov. 4, 2002

(51) Int. Cl. B29C 39/06

(52) U.S. Cl. 264/145; 264/157; 264/166

(57) ABSTRACT

A method of fabricating discrete risers for shelving units includes the step of providing a plurality of openable and closable mold segments arranged end to end along a continuous path, and circulating the plurality of mold segments through multiple revolutions of the continuous path such that the mold segments are closed while traveling along a molding section of the continuous path. A molten stream of plastic is continuously extruded at an upstream end of the molding section and into mold cavities of the closed or closing mold segments. A pressure differential is applied to the mold cavities of the closed mold segments to conform the molten stream of plastic to the mold cavities. A continuous train of interconnected risers is ejected at a downstream end of the molding section. Discrete risers are separated from the continuous train.

### FIELD OF THE INVENTION

The present invention is directed to risers for modular shelving units, and more particularly to a method of continuously manufacturing such risers.

### BACKGROUND OF THE INVENTION

Modular shelving units are known in the prior art for storing objects. Many known shelving units have a plurality of stacked and spaced apart shelves, each shelf, other than perhaps a bottom most shelf, being supported by a plurality of shelf risers. The risers are know to attach at one end to a lower shelf and to support a next vertically adjacent shelf spaced above the lower shelf. Multiple shelves can be stacked in such a manner.

Examples of such modular shelving units are disclosed in U.S. Pat. Nos. 6,179,339 and 6,178,896. These types of shelving units are formed from molded plastic components. Currently known molding processes utilized to fabricate the individual shelves and the discrete risers can vary, but heretofore have a number of limitations that significantly affect manufacturing productivity, part cost, fabrication time, and tooling and other capital expenditure.

For example, injection molding techniques are almost exclusively used to fabricate plastic molded modular shelves because the shelves typically have three dimensional, multi-faceted shapes. Injection molding is also almost exclusively used to manufacture high end or high price point units, including both the risers and the shelves. This is because these high end units often also have multi-faceted surface risers. Such risers often have complex surface and shape characteristics (for functionality and aesthetics) that can only be fabricated using a discrete, cyclical molding process. Other than injection molding, thermoforming and blow molding processes, both also discrete part and cyclical procedures, are sometimes used to fabricate such risers.

Injection molding and other discrete part, cyclical molding processes require individual mold cavities. Also, each discrete mold cavity can only produce a single part during a given molding cycle. Each cycle takes a predetermined amount of time to complete. Each mold must be opened and closed for each discrete cycle. If the number of parts per cycle is to be increased, more mold cavities must be produced. Molds can be very expensive to make and maintain.

Injection molding is also done at high pressures, which further limits productivity. To change a characteristic of a part molded in such a manner requires shutting down the mold machine, altering or replacing the mold or mold cavities, and restarting. Something as simple as changing material selection, wall thickness, or part length can require serious tinkering or complete mold cavity replacement.

It is also known to fabricate shelf risers using a continuous extrusion process wherein an extruded tube is subsequently cut to length to form plural risers. However, such a process limits the shape of the risers to having a uniform cross section shape over the entire riser length, regardless of the particular cross section shape. The most common extruded riser shape is a circular cylinder. These types of risers are often found on low cost, lower quality, low price point shelving units.

Often, one desires a riser to have specific surface, size, or shape features that vary over the riser circumference and/or length. Such three dimensional, multi-faceted risers must be formed utilizing a discrete molding process such as injection molding. These types of risers are often found on high end units.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a modular shelving unit assembled with shelf risers constructed utilizing a method in accordance with the teachings of the present disclosure.

FIG. 2 shows an enlarged exploded view of a portion of a shelf and a riser of the shelving unit shown in FIG. 1.

FIG. 3 shows a cross section of a portion of a riser in one example and constructed in accordance with the teachings of the present disclosure.

FIG. 4 shows a front elevation and schematic view of one example of a machinery set up used to practice the method in accordance with the teachings of the present invention.

FIGS. 5A and 5B show alternative examples of continuously molded risers constructed in accordance with the teachings of the present disclosure.

FIG. 6 shows a cross section of a portion of a riser in another example and constructed in accordance with the teachings of the present invention.

FIG. 7 shows a cross section of a portion of a riser in yet another example and constructed in accordance with the teachings of the present disclosure.

FIG. 8 shows a schematic end view of pairs of mold blocks of the machinery set up shown in FIG. 3.

FIG. 9 shows another alternative example of continuously molded risers constructed in accordance with the teachings of the present disclosure.

FIG. 10 shows another example of a mold portion of a machinery set up used to practice the method in accordance with the teachings of the present invention.

### DETAILED DESCRIPTION OF THE PREFERRED EMBODIMENTS

The methods described herein in accordance with the teachings of the present disclosure solve or improve upon the problems and limitations described above, as well as other deficiencies, that are known in the prior art methods and risers. For example, the disclosed method permits continuous formation of a string or chain of interconnected risers, similar to an extrusion process, that can be cut or separated into discrete risers. However, the disclosed method also permits formation of risers having discrete features previously capable of being formed using only an intermittent or non-continuous molding process.

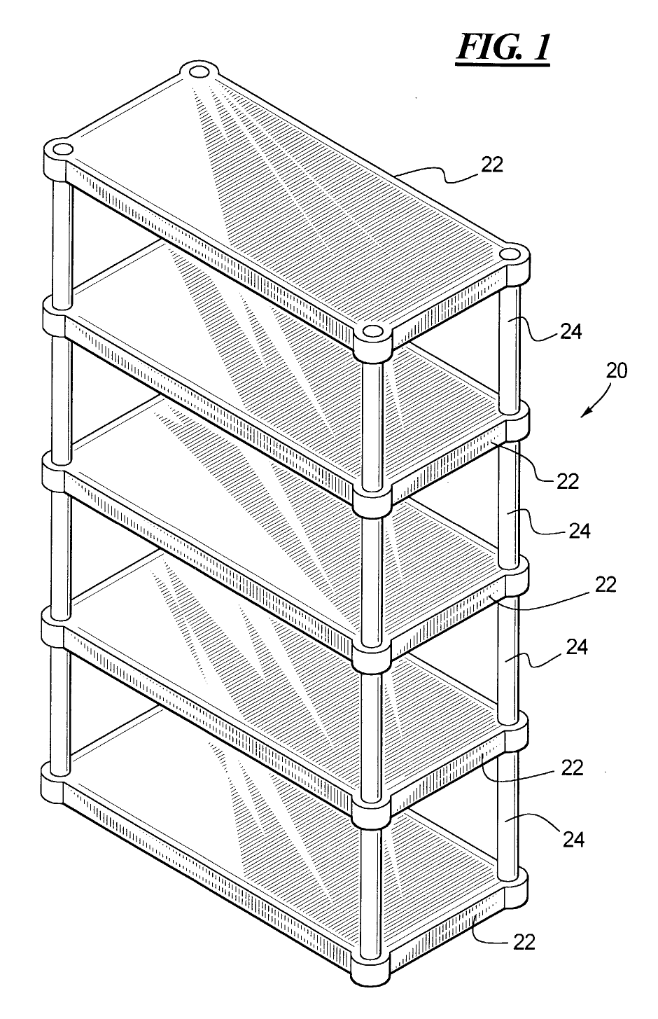

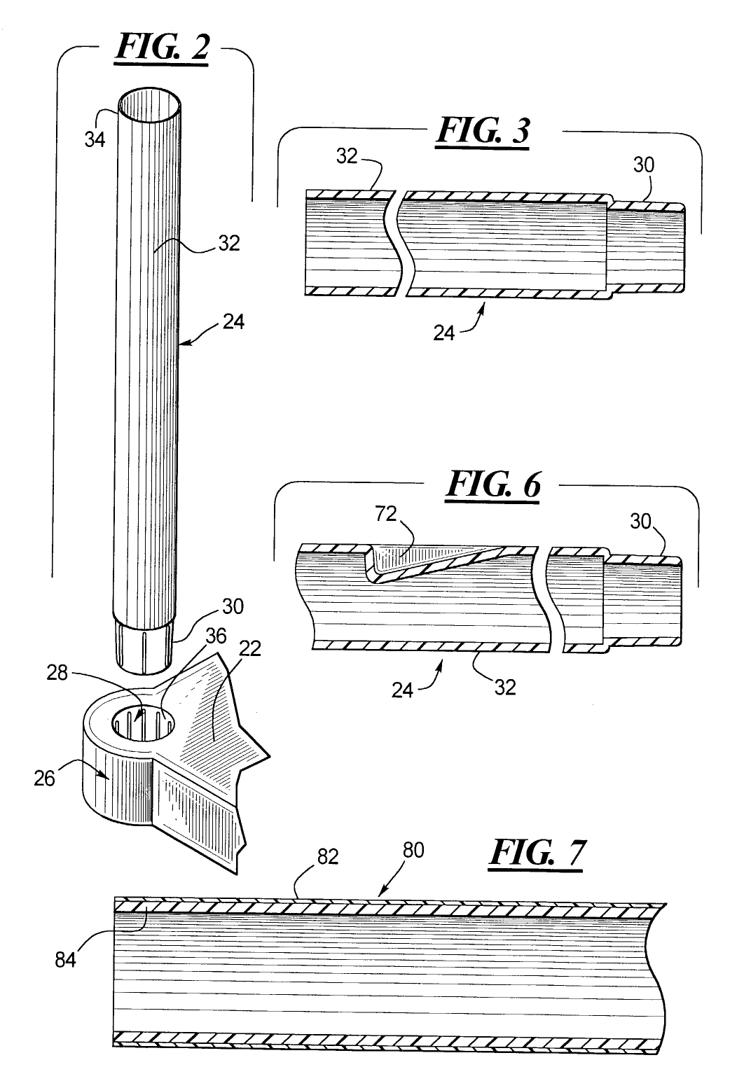

Referring now to the drawings, FIG. 1 illustrates a perspective view of a modular shelving unit 20 suited to reap the benefits of the methods described herein. The unit 20 has a plurality of shelves 22 stacked and spaced apart from one another by a plurality of risers 24. As shown in FIG. 2, each shelf has a socket 26 that defines a receptacle 28 provided in each corner. As will be evident to those having ordinary skill in the art, the particular shape, size, and construction of the shelves 22 can vary considerably and yet benefit from the teachings of the present disclosure. One desirable trait for modular structures of this type is that all of the shelves are essentially identical to one another and all of the risers are identical to one another, rendering unit assembly easy, simplifying both part and tooling fabrication, and reducing unit cost and complexity.

In the disclosed example, each riser 24 has a bottom end 30, an exterior surface 32, and a top end 34. Each receptacle 28 is adapted such that the bottom end 30 of a riser 24 can be inserted into a top opening 36 of the receptacle. Similarly, each receptacle 28 is also adapted such that a top end 34 of a riser can be inserted into a bottom opening (not shown) of the receptacle.

As will be evident to those having ordinary skill in the art, each of the risers 24 can be of an essentially unitary structure having the a uniform shaped cross-section, wall thickness, and surface feature configuration over its entire length. For example, a simple riser 24 can be a circular cylindrical extruded tube. The tube can then simply but cut to length as appropriate. Though often extruded, such a riser construction can be easily manufactured in accordance with the prior art teachings, if desired. However, it is often desirable, especially for higher price point, more sophisticated products, to use multi-faceted risers 24 having shapes, configurations, cross-sections, and wall thicknesses that vary over a circumference or over the length of the riser.

As shown in FIG. 2, each riser 24 disclosed herein is one example well suited for the teachings of the present disclosure. The upper end 34 mirrors the exterior surface 32 over a majority of the length of the riser. However, the lower end 30 has a configuration that is different than the upper end 34 and the exterior surface 32. In this example, the lower end 30 has a slightly smaller diameter, is tapered to a narrower diameter at its distal end, and includes a plurality of axially arranged ribs. The construction of the lower end 30 shown in this disclosure is merely one of many possible variations of a riser with a multi-faceted or variable shape and configuration over different portions of the part.

In the prior art, the riser 24 shown and described herein would necessarily be manufactured using a discrete part, cyclical molding process, such as injection molding as described above. The method described herein in accordance with the teachings of the present disclosure renders it possible to continuously mold an interconnected, continuous train of risers 24 using a continuous molding process.

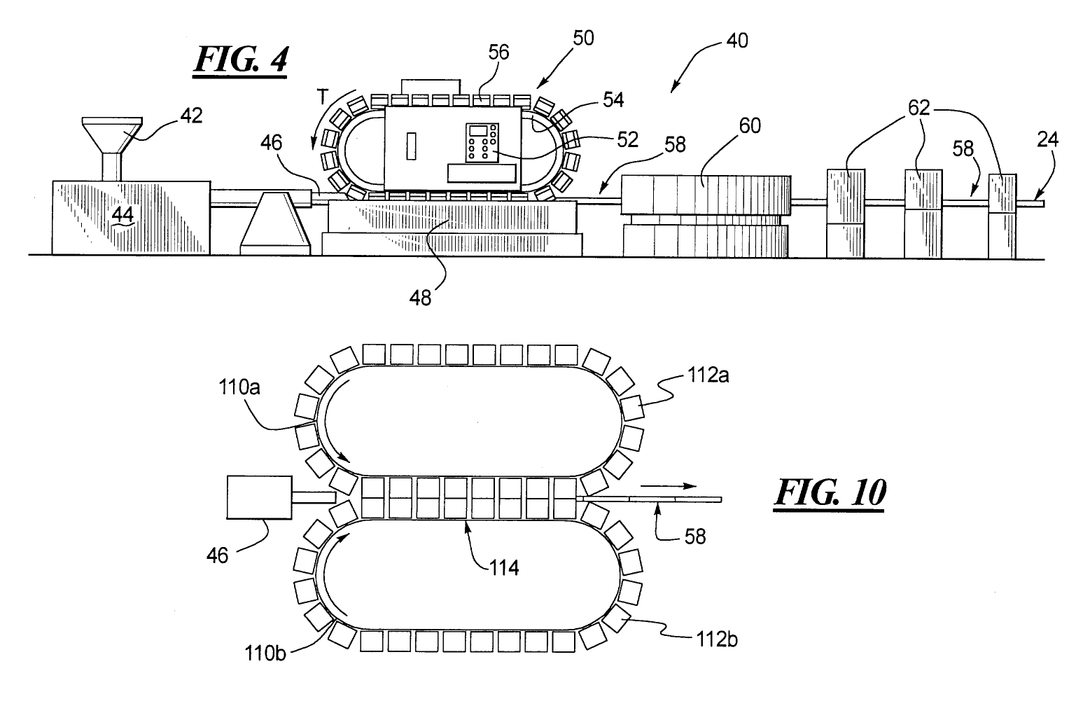

To perform the process in accordance with the teachings of the present disclosure, a continuous molding machine 40 is utilized and is illustrated in FIG. 4. The machine 40 is a hybrid of technologies including plastic extrusion and vacuum forming or blow molding. As shown in FIG. 4, the machine generally includes a hopper 42 into which the bulk plastic material, usually available in pellet form, is added. The hopper 42 delivers the material to an extruder 44 that heats and appropriately mixes the bulk material. The heated and mixed material, when ready, is fed to an extrusion die 46 from which an extruded stream of plastic is ejected.

The molten stream of plastic is fed to an upstream end (left side in FIG. 4) of a continuous forming machine 50 which, in one form is known in the art as a pipe corrugator for forming continuous lengths of corrugated drainage pipe and the like. Such a machine is known for forming continuous lengths of plastic corrugated pipe made from high density polyethylene (HDPE), a relatively soft, non-brittle material. Heretofore, it has not been known to utilize such a machine for fabricating other types of products, especially small, discrete molded products such as risers. Also, it has not been considered to utilize such a machine to mold much more brittle homopolymer polypropylene with mineral fillers, a material common for use with riser technology.

The forming machine 50 generally includes a control panel for selecting and setting the various parameters of the process. The forming machine 50 also has a continuous track 54 arranged in a circuitous path, such as an oval track as shown in this example. The track 54 lies generally perpendicular to horizontal in this example. A plurality of mold segments 56 are carried on and conveyed along the continuous track 54. A chain drive, belt drive, or the like conveys the mold segments continuously in a direction “T” as illustrated. The forming machine 50 is supported on a base structure 48. The base structure can house many elements of the machine including motors, vacuum pumps, air compressors, and the like as needed.

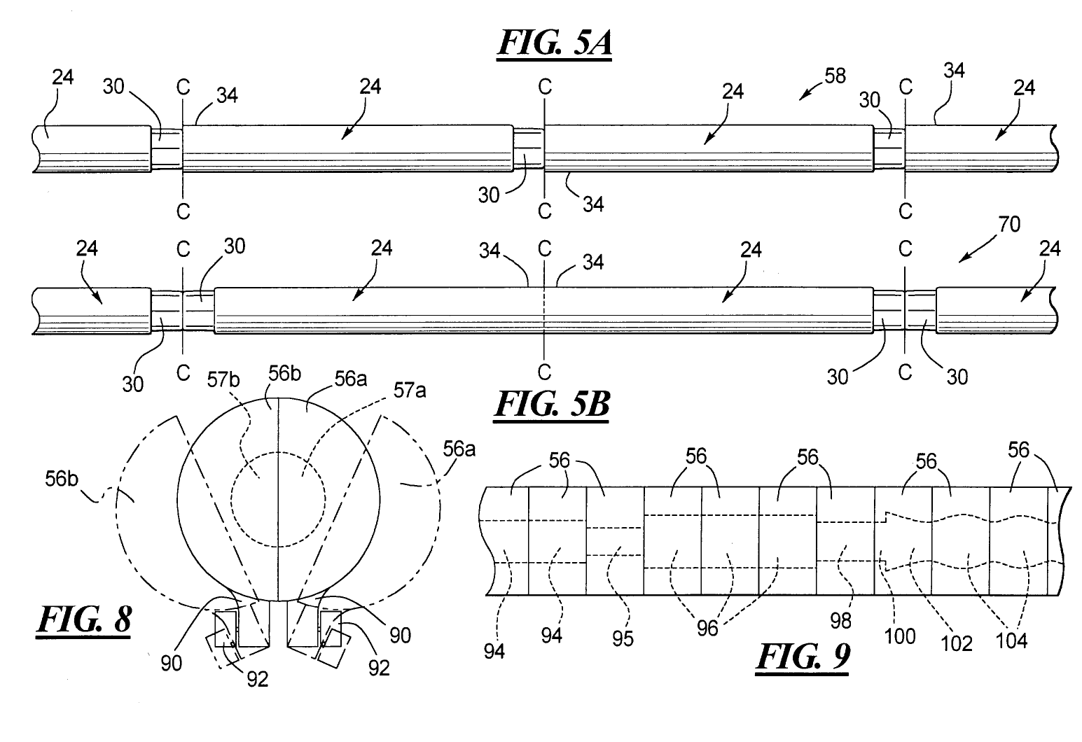

In this example, the mold segments 56 are arranged in pairs (see FIG. 8 and accompanying description below) and each pair travels in unison around the track 54, opening and closing in a clamshell manner. In operation, the mold segment pairs are open while traveling around the curved end sections and the upper linear section of the track 54. The mold segment pairs 56 close onto the continuous molten stream of plastic while traveling along the bottom linear section or molding section of the circuitous path. FIG. 10 and the accompanying description below illustrate one possible alternative arrangement for a track and mold segment device.

Generally speaking, the molten stream of plastic is conformed to mold cavities within the mold segments 56 as they travel along the molding section of the circuitous path of the track 54. A continuous train 58 of interconnected risers 24 is ejected from the downstream end (right hand side in FIG. 4) of the forming machine 50 and is passed to a cooling apparatus 60. In one example, the cooling apparatus 60 is a water bath utilizing cool water jets, for example, to cool the continuous train 58 of risers. The cooling apparatus 60 can alternatively be an air cooling bath in which cool air is moved over the continuous train 58. As will be evident to those having ordinary skill in the art, the cooling apparatus 60 can vary considerably without departing from the spirit and scope of the present invention.

In one example, the mold segments 56 entering the molding section of the circuitous path are heated. The mold segments can be cooled as they approach the downstream end where the mold segments will be opened to release the continuous train 58 of risers 24. Thus, the mold segments themselves can, in one example, be used to assist in cooling the continuous train 58 of risers.

As generally identified at 62 in FIG. 4, downstream operations can be performed on the continuous train, as necessary. For example, flash can be removed from the train or the discrete parts. Also, secondary cooling operations can be performed. Also, cutting and/or trimming steps can be performed. Ultimately, the discrete risers 24 are cut or separated from the continuous train 58.

In order to form the continuous train 58 of risers 24 from the extruded stream of plastic, a pressure differential is applied to the plastic material within the mold cavities of the mold segments 56 while traveling along the molding section of the track. In one example, a vacuum or negative pressure can be applied at mold cavity surfaces within the mold segments 56 as they travel along the molding section. As noted above, vacuum pumps (not shown) can be provided as part of the machine 50. The vacuum or negative pressure draws the extruded plastic material against the cavity walls to form the riser exterior shape and wall thickness.

In an alternative example, a positive pressure (i.e., blow mold type flow) can be applied internal to the molten stream of plastic in order to force the plastic material against the mold cavity walls. This can be accomplished in a number of ways. The air pressure can be blown through the molten stream of plastic at the extrusion die 46, or can be blown into the extruded stream of plastic as it is captured between closed mold segments 56 in the molding section. This can be done by piercing the stream of plastic with a small needle within the mold cavity, and forcing air through the needle into the plastic stream. Other methods of applying a pressure differential to the molten stream are also certainly within the purview of the present invention.

Turning next to FIGS. 5A and 5B, two examples of a continuous chain configuration for interconnected risers are illustrated. In FIG. 5A, a continuous chain 58 is illustrated wherein each riser 24 is oriented in the same direction as the adjacent risers. The risers 24 can be separated along the cut lines “C” shown in the drawing. The cut is between the lower end 30 of one riser and the adjacent and interconnected upper end 34 of the next adjacent riser 24. As will be evident to those having ordinary skill in the art, the chain 58 as illustrated can be formed while traveling in either direction.

FIG. 5B illustrates one alternative riser orientation in a continuous train 70. In this example, the lower ends 30 of adjacent risers 24 are formed abutting one another. Thus, the upper ends 34 of adjacent risers are also formed abutting one another. In order to separate risers, the continuous train 70 must be cut along the lines C between both the adjacent lower ends 30 and the adjacent upper ends 34 for sequentially adjacent risers.

As will be evident to those having ordinary skill in the art, the shape, size, and configuration of the risers can vary substantially from those shown in the drawings, such as those illustrated in FIGS. 5A and 5B. The riser configuration 24 disclosed herein is provided merely to illustrate aspects of the present invention, and is not intended to limit in any way the scope of the disclosure. For example, the process disclosed herein can be used to form, in essence and as noted above, a uniformly shaped cylindrical tube extrusion that is simply cut to desired lengths. This can be done easily and efficiently by attaching mold segments 56 to the track, each having an identical mold cavity. Uniform risers can then be cut to length as desired. Also, other mold segments for producing risers or riser features having shapes completely different than those illustrated herein can be achieved by swapping mold segments as needed.

In another example, FIG. 6 illustrates a portion of a riser 24 having a surface feature or recess 72. The recess 72 can be formed utilizing the continuous forming method disclosed herein, whereas such a riser feature could heretofore only be formed using a discrete par, cyclical molding processes. The riser 24 illustrated in FIG. 6 has an exterior surface 32 and a lower end configuration otherwise identical to those disclosed in prior examples. However, in this example, the riser also includes the generic surface feature 72. To form a feature such as the feature 72, a mold cavity with surface characteristics to form the feature must simply be provided in the appropriate sequence along the plurality of segments 56 in the forming machine 50.

The process disclosed herein is also equally well suited for producing highly complex multi-layer riser structures. For example, FIG. 7 illustrates a multi-layer riser 80 having an interior layer 84 that defines a bulk of the riser structure. The riser 80 also has an exterior layer 82 formed over and simultaneously with the interior layer 84. To fabricate this structure, the molten stream of plastic can be extruded from the extrusion die 46 with an inner material and an outer material extruded simultaneously, one interior to the other. Molding such as structure has heretofore been difficult, if not impossible using even the known discrete part, cyclical molding processes such as injection molding. By utilizing the process described herein, risers can be continuously fabricated and can be fabricated in single layer or multi-layer form.

The riser 80 has the benefit of utilizing a cheaper bulk material 84 for producing a majority of the structure. No color dyes or additives need be added to the material to form the inner layer 84, if none are desired. A skin or outer layer 82 can be formed from a more expensive, and if desired, colored or dyed material to provide a pleasing esthetic appearance for the riser 80. Other riser functions and characteristics can be achieved using the multi-layered structure, depending upon material selection.

FIG. 8 illustrates a simplified schematic showing a function of the mold segments 56. In one example, the mold segments 56 are provided in segment pairs shown as segment 56a and 56b. Only one half of each pair is visible in the manner shown in FIG. 4. The mold segment pair 56a and 56b shown in FIG. 8 is illustrated in the closed position, with the open position illustrated in phantom. As the mold segment pair 56a and 56b travels around the circuitous path on the track 54, the mold segments are open while traveling along the top section and around the curves and move from the open position to the closed position at the upstream end of the molding section. The mold segments remain closed until reaching the downstream end where they move from the closed position to the open position to release the molded continuous train 58 of risers 24.

Though not essential to the present invention, the mold segments ride within guides (not shown) on the tracks. In one example, the mold segments each have mounting ears 90 extending from the mold segment 56. Rollers 92 are carried on the guide ears 90 and are received in the guides of the track 54. The position and orientation of the guides in the track change in order to open and close the mold segment pairs 56a and 56b at the appropriate locations.

FIG. 9 illustrates schematically a plurality of adjacent mold segments 56 and illustrates in phantom examples of mold cavities provided therein. FIG. 9 is useful in describing a number of features that fall within the scope of the present disclosure. For example, as can be seen in FIG. 9, the mold segments 56 can be arranged and provided on the track 54 such that a continuous train of risers is formed wherein adjacent risers in the train are different from one another. Prior examples described herein show a train of identical risers. For example, the cavities 94 and 95 can be utilized to form a riser of one size with an end configuration of a different size, respectively. The mold cavities 96 and 98 can be used to form a completely different riser configuration and size and an end configuration and size. Similarly, more complex shapes and configurations can be formed as illustrated by the cavities 100, 102, and 104. Mold cavities within the mold segments 56 can be formed in virtually any configuration as desired in order to form a myriad of different riser configurations, structures, and features.

FIG. 9 is also useful to illustrate the arrangement of mold cavities within adjacent mold segments 56. In the molding section of the circuitous path, the closed mold segments 56 define a continuous mold tunnel through the closed mold segments to produce the continuous train of risers.

Another advantage of the process described in this disclosure is that change-over from fabricating one type of riser to fabricating another type of riser is made highly efficient, relatively inexpensive, and quite simple. A worker need only remove selected ones of the mold segments 56, if not all of the segments, and replace them 20, with segments having different mold cavity forms in order to achieve the desired change over. The entire plurality of mold segments 56 of the forming machine can be swapped for different mold segments, or only partial sections of the mold segments 56 need be swapped out, as desired.

FIG. 10 illustrates one alternative mold segment and track arrangement that can be utilized in accordance with the teachings of the present invention. FIG. 10 illustrates a top plan view of a pair of circuitous tracks 110a and 110b that are driven in opposite directions. The tracks 110a and 110b lie parallel to one another in the same plane which is oriented generally parallel to the horizon. Each track 110a and 110b also carries a plurality of individual mold segments 112a or 112b, respectively, of mold segment pairs 112. The mold segment pairs 112 are open when traveling one the curved end sections of the tracks 110a and 110b and on the outer, opposite linear sections. The mold segment pairs 112 are closed when traveling along the facing, adjacent linear tracks sections that defines a molding section or tunnel 114. The molten plastic is delivered to the molding section 114 at an upstream end, and a formed chain of risers exits the downstream end of the tunnel region, as in the prior described example. As will be evident to those having ordinary skill in the art, the tracks 110a and 110b can alternatively be oriented in a vertical plane with the molding section or tunnel 114 being oriented either vertically or horizontally, as desired.

The disclosed process is extremely flexible, relatively inexpensive to run, highly efficient in fabricating risers in a continuous manner, and can reduce overall manufacturing cost and production time significantly, once capital outlay for the machine 40 is paid.

Although certain methods and risers have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A method of fabricating discrete risers for shelving units, the method comprising the steps of:
providing a plurality of openable and closable mold segments arranged end to end along a continuous path;
circulating the plurality of mold segments through multiple revolutions of the continuous path such that the mold segments are closed while traveling along a molding section of the continuous path;
continuously extruding a molten stream of plastic at an upstream end of the molding section and into mold cavities of the closed or closing mold segments;
applying a pressure differential to the mold cavities of the closed mold segments to conform the molten stream of plastic to the mold cavities;
ejecting a continuous train of interconnected risers at a downstream end of the molding section; and
separating discrete risers from the continuous train.

2. A method according to claim 1, further comprising the step of cooling the discrete risers.

3. A method according to claim 2, wherein the step of cooling is performed on the continuous train of discrete risers.

4. A method according to claim 2, wherein the step of cooling is performed on the discrete risers after the step of separating.

5. A method according to claim 3, wherein the step of cooling includes passing the continuous train of discrete risers through a water bath.

6. A method according to claim 1, wherein the step of providing a plurality of mold segments further comprises providing a plurality of openable and closable mold segment pairs.

7. A method according to claim 6, wherein the step of circulating further comprises circulating the mold segment pairs around at least one continuous track through a plurality of revolutions, and wherein the plurality of mold segment pairs are closed while in the molding section and open when not in the molding section during each revolution.

8. A method according to claim 7, wherein the mold segment pairs are carried on a single track oriented generally perpendicular to horizontal, and open and close in a clamshell manner.

9. A method according to claim 7, wherein the mold segment pairs are carried on a pair of adjacent tracks circulating in opposite directions, one mold segment of each pair carried on a respective one of the pair of tracks, and wherein the pair of tracks are arranged generally in the same plane which is generally parallel to horizontal.

10. A method according to claim 1, wherein the step of extruding further comprises extruding multiple streams of molten plastic concentric to one another to form multi-layered discrete risers.

11. A method according to claim 10, wherein the step of extruding further comprises extruding at least two different molten plastic material streams.

12. A method according to claim 11, wherein the step of extruding further comprises extruding at least two different color molten plastic material streams.

13. A method according to claim 1, wherein the step of applying a pressure differential further comprises applying a negative pressure to mold cavity surfaces within the mold cavities when in the molding section.

14. A method according to claim 13, wherein the step of applying a pressure differential further comprises applying a positive pressure within the stream of molten plastic when in the molding section.

15. A riser for a modular shelving unit fabricated utilizing the method according to claim 1, the riser having a shape that varies between a first end and a second end of the riser.

16. A method according to claim 1, wherein the step of circulating further comprises coupling a plurality of mold segment pairs to at least one circuitous track, and circulating the at least one circuitous track through multiple revolutions to sequentially close and open the plurality of mold segment pairs at least once during each revolution.

17. A method according to claim 16, wherein the step of circulating opens and closes the plurality of mold segment pairs in a clam shell manner.

18. A method according to claim 16, wherein the step of circulating further comprises coupling each mold segment of the plurality of mold segment pairs to a respective track of a pair of circuitous tracks, the pair of tracks arranged generally parallel to one another in the same horizontal or vertical plane, and circulating each of the pair of circuitous tracks in opposite directions to sequentially close and open the plurality of mold segment pairs

19. A method according to claim 1, further comprising the steps of:
re-opening the closed mold segments at a downstream end of the molding section; and
discharging the continuous train of interconnected discrete risers from the mold segments during the step of re-opening.

20. A method according to claim 1, wherein the steps of providing and circulating result in the plurality of mold segments producing a plurality of different discrete risers in the continuous train.

21. A method according to claim 20, wherein the step of providing a plurality of mold segments further comprises providing a plurality of different shaped mold cavities within the mold segments to produce the plurality of different discrete risers.

22. A method according to claim 1, wherein the step of applying a pressure differential further comprises applying a vacuum to each of the discrete mold cavities of the closed mold segments.

23. A method according to claim 1, wherein each of the closed mold segments forms only a portion of one of the discrete risers.
